(19) United States
(12) Patent Application Publication
(10) Pub. No.: US 2015/0382130 A1
(43) Pub. Date: Dec. 31, 2015

(54) CAMERA BASED ADJUSTMENTS TO 3D SOUNDSCAPES

(71) Applicants: PATRICK CONNOR, Beaverton, OR (US); SCOTT P. DUBAL, Beaverton, OR (US)

(72) Inventors: PATRICK CONNOR, Beaverton, OR (US); SCOTT P. DUBAL, Beaverton, OR (US)

(21) Appl. No.: 14/318,559

(22) Filed: Jun. 27, 2014

(51) Int. Cl. H04S 7/00; G06T 7/00; H04S 1/00

(52) U.S. Cl. CPC H04S 7/304; H04S 1/005; G06T 7/0042; G06T 2207/10004; G06T 2207/30196

(57) ABSTRACT

Systems and methods may provide for obtaining an image of an individual wearing a headset and determining a head orientation of the individual based on the image. Additionally, a soundscape delivered to the individual via the headset may be adjusted based on the head orientation of the individual. In one example, adjusting the soundscape includes adjusting one or more of an audio delivery time difference between left and right channels of the soundscape, a volume difference between left and right channels of the soundscape, and a frequency component of the soundscape.

### TECHNICAL FIELD

Embodiments generally relate to immersive media experiences that include three-dimensional (3D) soundscapes. More particularly, embodiments relate to making camera based adjustments to 3D soundscapes for individuals wearing headsets.

### BACKGROUND

In conventional audio listening environments, multiple speakers may be positioned around a room to achieve a 3D effect with respect to the delivered audio. If a listener is wearing headphones, however, the sound source typically remains in a fixed position relative to the listener's head and the directional quality is lost. In recent developments, specialized headphones may track the head of the individual wearing the headphone, wherein the head tracking information may be used to process the audio channels so that they may approximate the sound that would be heard in a room having peripheral speakers. Specialized headphones, however, may be impractical because they include complex and expensive gyroscope or ultrasonic sensor technology in order to track the head of the wearer.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a camera based adjustment to a 3D soundscape according to an embodiment;

FIG. 2 is a flowchart of an example of a method of providing 3D soundscapes to headset wearers according to an embodiment; and

FIG. 3 is a block diagram of an example of a computing device according to an embodiment.

### DESCRIPTION OF EMBODIMENTS

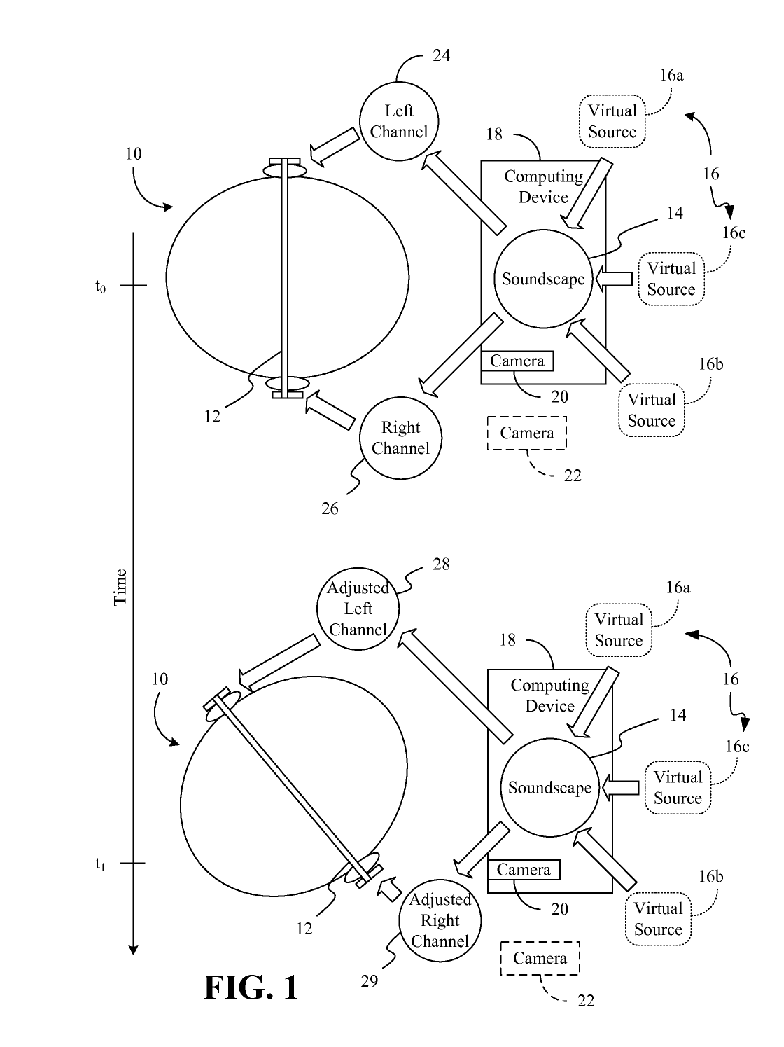

Turning now to FIG. 1, a top view of an immersive media environment is shown in which an individual 10 wearing a headset 12 (e.g., headphones, ear buds, etc.) receives a three-dimensional (3D) soundscape 14 via the headset 12. In the illustrated example, the immersive media environment includes one or more virtual sources 16 (16a-16c) of sound, wherein the sound from the virtual sources 16, as well as the position/location of the virtual sources 16 may collectively form the 3D soundscape 14. Thus, the virtual sources 16 might include instruments (e.g., in a multi-piece orchestra), people, augmented reality characters, animals (e.g., land, air, sea or space based), machines, airplanes, helicopters, and/or other sound-generating objects in a setting such as, for example, a movie, virtual world, game, and so forth.

As will be discussed in greater detail, a computing device 18 such as, for example, a desktop computer, notebook computer, tablet computer, convertible tablet, personal digital assistant (PDA), smart phone, mobile Internet device (MID), media player, etc., may generally use wired and/or wireless transmissions to deliver the soundscape 14 to the individual 10 via the headset 12. The illustrated computing device 18 also obtains images of the individual 10 (e.g., face, head, shoulders, torso and/or other body parts), determines the head orientation of the individual 10 based on the images, and automatically adjusts the soundscape 14 based on the head orientation of the individual 10. In one example, determining the head orientation of the individual 10 includes determining an intermediate orientation of the head of the individual 10 relative to the computing device 18, wherein the head orientation relative to the virtual sources 16 associated with the soundscape 14 is determined based on the intermediate orientation. Using a camera based approach to making adjustments to the soundscape 14 may enable the immersive media environment to be facilitated without a complex or costly headset 12. Indeed, the illustrated solution may be used with any type of headset 12.

More particularly, the illustrated soundscape 14 includes an audio signal having a left channel 24 and a right channel 26, wherein the left channel 24 may be delivered to the left ear of the individual 10 via the headset 12 and the right channel 26 may be delivered to the right ear of the individual 10 via the headset 12. In addition, an embedded camera 20 (e.g., user facing camera) and/or a peripheral camera 22 (e.g., security camera, web camera) may be used to capture/obtain an image of the individual 10. The captured image may in turn be used to determine the head orientation of the individual 10. The head orientation may be determined directly from an image of the ears, face and/or head of the individual 10. The head orientation may also be inferred from an image of other body parts of the individual 10 or of the individual's prior location (e.g., during a walking audio tour). Thus, if it is determined at time t₀ that the ears of the individual 10 are substantially equidistant to the computing device 18, the left channel 24 might be configured to contain, for example, louder sound content from a first virtual source 16a than from a second virtual source 16b. Similarly, the right channel 26 may be configured to contain louder sound content from the second virtual source 16b than from the first virtual source 16b.

Other characteristics of the soundscape 14 such as, for example, the delivery time difference between the left channel 24 and the right channel 26, may be set and/or adjusted based on the image of the individual 10. Thus, at illustrated time t₀, the computing device 18 might also configure the sound content from the first virtual source 16a to arrive at the left ear of the individual 10 earlier than the right ear of the individual 10. Similarly, the computing device 18 may configure the sound content from the second virtual source 16b to arrive at the right ear of the individual 10 earlier than the left ear of the individual 10.

In yet another example, a frequency component of the soundscape 14 such as, for example, the Doppler effect may be set and/or adjusted based on the image of the individual 10. More particularly, if the virtual sources 16 are moving at a relatively high speed in the immersive media environment (e.g., helicopter flying overhead), the frequency of the sound generated by the virtual sources 16 may vary depending on their position relative to the ears of the individual 10. Thus, if the virtual sources 16 are moving from right to left from the perspective of the ears of the individual 10, at illustrated time t₀, the computing device 18 may ensure that the sound content from the second virtual source 16b has a higher frequency than the sound content from the first virtual source 16a. Similarly, if the virtual sources 16 are moving from left to right from the perspective of the ears of the individual 10, the computing device 18 might ensure that the sound content from the first virtual source 16a has a higher frequency than the sound content from the second virtual source 16b.

If, at time t₁, an image of the individual 10 indicates that the individual 10 has rotated his or her head to the left relative to the soundscape 14, the computing device 18 may automatically adjust the soundscape 14 to ensure that the sound content from the virtual sources 16 automatically reflects the change in head orientation of the individual 10. Thus, the audio signal of the soundscape 14 may include an adjusted left channel 28 and an adjusted right channel 29. The adjustments may be in terms of the audio delivery time difference between the adjusted left channel 28 and the adjusted right channel 29, the volume difference between the adjusted left channel 28 and the adjusted right channel 29, a frequency component of the soundscape 14, and so forth.

Thus, at time t₁, the computing device 18 may, for example, configure the adjusted left channel 28 to reduce the volume of the sound content from the each of the virtual sources 16 because the virtual sources 16 are farther away from the left ear of the individual 10 at time t₁. Similarly, the computing device 18 might configure the adjusted right channel 29 to increase the volume of the sound content from each of the virtual sources 16 because the virtual sources 16 are closer to the right ear of the individual 10 at time t₁. Additionally, at time t₁, the computing device 18 may configure the adjusted left channel 28 to delay delivery of the sound content from the virtual sources 16 to the left ear of the individual 10 and configure the adjusted right channel 29 to speed up delivery of the sound content from the virtual sources 16 to the right ear of the individual 10. In yet another example, the computing device 18 might reduce the frequency difference between the adjusted left channel 28 and the adjusted right channel 29 to minimize the Doppler effect because the illustrated virtual sources 16 are no longer moving laterally relative to the individual 10.

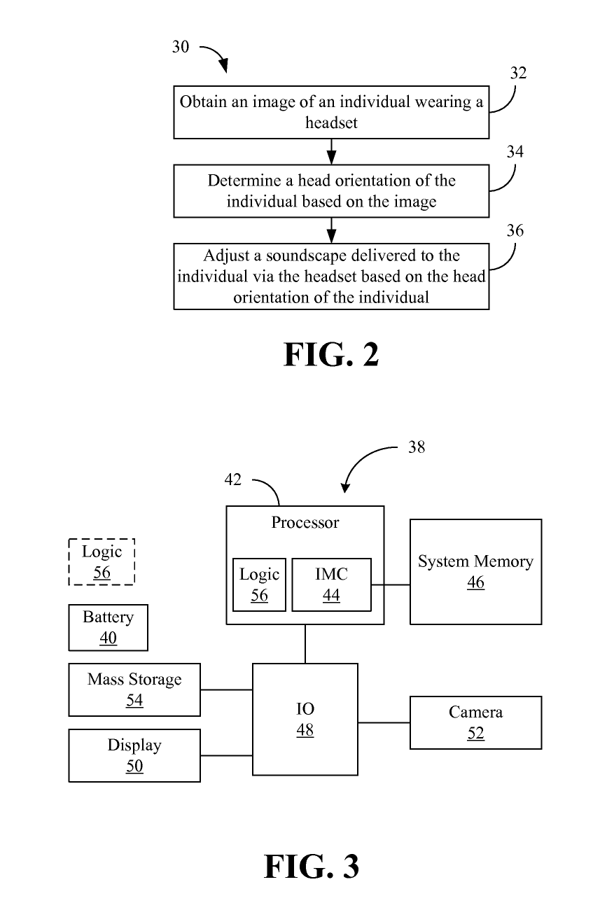

Turning now to FIG. 2, a method 30 of providing 3D soundscapes is shown. The method 30 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 30 may be written in any combination of one or more programming languages, including an object oriented programming language such as Java, Smalltalk, C++ or the like and conventional procedural programming languages, such as the “C” programming language or similar programming languages.

Illustrated processing block 32 provides for obtaining an image of an individual wearing a headset, wherein a camera embedded in a mobile device and/or a peripheral camera may be used to obtain the image. For example, a series of still images and/or video frames may be captured of a physical environment containing the individual at block 32. Additionally, block 34 may determine the head orientation of the individual based on the image. In the case of an embedded camera, an intermediate orientation of the head of the individual may be determined relative to the mobile device, wherein the head orientation relative to the soundscape (e.g., one or more virtual sources of sound in an immersive media environment) may be determined based on the intermediate orientation.

Block 36 may adjust a soundscape delivered to the individual via the headset based on the head orientation of the individual. Adjusting the soundscape may include adjusting, for example, the audio delivery time difference between left and right channels of the soundscape, the volume difference between left and right channels of the soundscape, a frequency component (e.g., Doppler effect) of the soundscape, and so forth. Other audio characteristics used by the brain for sound direction and distance perception may also be adjusted at block 36.

FIG. 3 shows a computing device 38. The computing device 38 may be part of a mobile device/platform having computing functionality (e.g., PDA, notebook computer, tablet computer), communications functionality (e.g., wireless smart phone), imaging functionality, media playing functionality (e.g., smart television/TV), wearable functionality (e.g., watch, eyewear, headwear, footwear, jewelry) or any combination thereof (e.g., MID). The computing device 38 may be readily substituted for the computing device 18 (FIG. 1), already discussed. In the illustrated example, the device 38 includes a battery 40 to supply power to the device 38 and a processor 42 having an integrated memory controller (IMC) 44, which may communicate with system memory 46. The device 38 may alternatively be powered by another type of power source such as, for example, induction power or a fuel cell. The system memory 46 may include, for example, dynamic random access memory (DRAM) configured as one or more memory modules such as, for example, dual inline memory modules (DIMMs), small outline DIMMs (SODIMMs), etc.

The illustrated device 38 also includes an input output (10) module 48, sometimes referred to as a Southbridge of a chipset, that functions as a host device and may communicate with, for example, a display 50 (e.g., touch screen, liquid crystal display/LCD, light emitting diode/LED display), a camera 52, and mass storage 54 (e.g., hard disk drive/HDD, optical disk, flash memory, etc.). The illustrated processor 42 may execute logic 56 (e.g., logic instructions, configurable logic, fixed-functionality logic hardware, etc., or any combination thereof) configured to obtain images of an individual wearing a headset, determine the head orientation of the individual based on the images, and adjust a soundscape delivered to the individual via the headset based on the head orientation of the individual. Thus, the logic 56 may perform one or more aspects of the method 30 (FIG. 2), already discussed.

The camera 52 may be an embedded camera, a peripheral camera, or any combination thereof. In the case of an embedded camera, the head orientation of the individual may be determined based on an intermediate orientation of the head of the individual relative to the device 38. Thus, the embedded camera example might be advantageous when, for example, the individual is wearing a headset while watching an immersive movie on the display 50 of the device 38 and rotates his or her head during the movie. In the case of a peripheral camera, the head orientation of the individual may be determined relative to one or more virtual sources of sound in the soundscape. Thus, the peripheral camera example may be advantageous when, for example, the individual is wearing a headset while walking through a museum audio tour containing virtual sources of sound such as, for example, dinosaurs, airplanes, etc. In such a case, the logic 56 may also determine which player is with which individual in a group of people and provide personalized audio adjustments to each individual in the group. One or more aspects of the logic 56 may alternatively be implemented external to the processor 42. Additionally, the processor 42 and the JO module 48 may be implemented together on the same semiconductor die as a system on chip (SoC).

### ADDITIONAL NOTES AND EXAMPLES

Example 1 may include a computing device to facilitate an immersive media experience, comprising a battery to supply power to the device and logic, implemented at least partly in fixed-functionality hardware, to obtain an image of an individual wearing a headset, determine a head orientation of the individual based on the image, and adjust a soundscape delivered to the individual via the headset based on the head orientation of the individual.

Example 2 may include the computing device of Example 1, wherein the logic is to adjust one or more of an audio delivery time difference between left and right channels of the soundscape, a volume difference between left and right channels of the soundscape and a frequency component of the soundscape.

Example 3 may include the computing device of Example 2, wherein the frequency component is to include a Doppler effect.

Example 4 may include the computing device of any one of Examples 1 to 3, wherein the logic is to determine an intermediate orientation of the head of the individual relative to a mobile device, and wherein the head orientation is to be determined based on the intermediate orientation.

Example 5 may include the computing device of Example 4, further including an embedded camera, wherein the logic is to use the embedded camera to obtain the image.

Example 6 may include the computing device of any one of Examples 1 to 3, wherein the logic is to use a peripheral camera to obtain the image.

Example 7 includes a method of facilitating an immersive media experience, comprising obtaining an image of an individual wearing a headset, determining a head orientation of the individual based on the image, and adjusting a soundscape delivered to the individual via the headset based on the head orientation of the individual.

Example 8 may include the method of Example 7, wherein adjusting the soundscape includes adjusting one or more of an audio delivery time difference between left and right channels of the soundscape, a volume difference between left and right channels of the soundscape and a frequency component of the soundscape.

Example 9 may include the method of Example 8, wherein the frequency component includes a Doppler effect.

Example 10 may include the method of any one of Examples 7 to 9, wherein determining the head orientation of the individual includes determining an intermediate orientation of the head of the individual relative to a mobile device, wherein the head orientation is determined based on the intermediate orientation.

Example 11 may include the method of Example 10, further including using a camera embedded in the mobile device to obtain the image.

Example 12 may include the method of any one of Examples 7 to 9, further including using a peripheral camera to obtain the image.

Example 13 includes at least one non-transitory computer readable storage medium comprising a set of instructions which, when executed by a computing device, cause the computing device to obtain an image of an individual wearing a headset, determine a head orientation of the individual based on the image, and adjust a soundscape delivered to the individual via the headset based on the head orientation of the individual.

Example 14 may include the at least one non-transitory computer readable storage medium of Example 13, wherein the instructions, when executed, cause a computing device to adjust one or more of an audio delivery time difference between left and right channels of the soundscape, a volume difference between left and right channels of the soundscape and a frequency component of the soundscape.

Example 15 may include the at least one non-transitory computer readable storage medium of Example 14, wherein the frequency component is to include a Doppler effect.

Example 16 may include the at least one non-transitory computer readable storage medium of any one of Examples 13 to 15, wherein the instructions, when executed, cause a computing device to determine an intermediate orientation of the head of the individual relative to a mobile device, and wherein the head orientation is to be determined based on the intermediate orientation.

Example 17 may include the at least one non-transitory computer readable storage medium of Example 16, wherein the instructions, when executed, cause a computing device to use a camera embedded in the mobile device to obtain the image.

Example 18 may include the at least one non-transitory computer readable storage medium of any one of Examples 13 to 15, wherein the instructions, when executed, cause a computing device to use a peripheral camera to obtain the image.

Example 19 includes an apparatus to automatically adapt soundscapes, comprising logic, implemented at least partly in fixed-functionality hardware, to obtain an image of an individual wearing a headset, determine a head orientation of the individual based on the image, and adjust a soundscape delivered to the individual via the headset based on the head orientation of the individual.

Example 20 may include the apparatus of Example 19, wherein the logic is to adjust one or more of an audio delivery time difference between left and right channels of the soundscape, a volume difference between left and right channels of the soundscape and a frequency component of the soundscape.

Example 21 may include the apparatus of Example 20, wherein the frequency component is to include a Doppler effect.

Example 22 may include the apparatus of any one of Examples 19 to 21, wherein the logic is to determine an intermediate orientation of the head of the individual relative to a mobile device, and wherein the head orientation is to be determined based on the intermediate orientation.

Example 23 may include the apparatus of Example 22, wherein the logic is to use a camera embedded in the mobile device to obtain the image.

Example 24 may include the apparatus of any one of Examples 19 to 21, wherein the logic is to use a peripheral camera to obtain the image.

Example 25 may include an apparatus to automatically adapt soundscapes, comprising means for performing the method of any one of Examples 7 to 12.

Thus, techniques described herein may provide a 3D soundscape for an immersive media environment that enables individuals wearing headsets to walk through, look around and interact in such a way that the sound sources maintain proper location for a more realistic perception. For example, if a wearer of a headset looks away from a display (e.g., in response to an off-screen sound), the sound sources may remain affixed to their respective objects independently from the user movement. Moreover, techniques may leverage user-facing cameras that are already pre-existing on many mobile devices. As a result, practical, low cost implementations of immersive media environments having directional sound and natural interactions may be achieved.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing device comprising:
a battery to supply power to the device; and
logic, implemented at least partly in fixed-functionality hardware, to:
obtain an image of an individual wearing a headset,
determine a head orientation of the individual based on the image, and
adjust a soundscape delivered to the individual via the headset based on the head orientation of the individual.

2. The computing device of claim 1, wherein the logic is to adjust one or more of an audio delivery time difference between left and right channels of the soundscape, a volume difference between left and right channels of the soundscape and a frequency component of the soundscape.

3. The computing device of claim 2, wherein the frequency component is to include a Doppler effect.

4. The computing device of claim 1, wherein the logic is to determine an intermediate orientation of the head of the individual relative to a mobile device, and wherein the head orientation is to be determined based on the intermediate orientation.

5. The computing device of claim 4, further including an embedded camera, wherein the logic is to use the embedded camera to obtain the image.

6. The computing device of claim 1, wherein the logic is to use a peripheral camera to obtain the image.

7. A method comprising:
obtaining an image of an individual wearing a headset;
determining a head orientation of the individual based on the image; and
adjusting a soundscape delivered to the individual via the headset based on the head orientation of the individual.

8. The method of claim 7, wherein adjusting the soundscape includes adjusting one or more of an audio delivery time difference between left and right channels of the soundscape, a volume difference between left and right channels of the soundscape and a frequency component of the soundscape.

9. The method of claim 8, wherein the frequency component includes a Doppler effect.

10. The method of claim 7, wherein determining the head orientation of the individual includes determining an intermediate orientation of the head of the individual relative to a mobile device, wherein the head orientation is determined based on the intermediate orientation.

11. The method of claim 10, further including using a camera embedded in the mobile device to obtain the image.

12. The method of claim 7, further including using a peripheral camera to obtain the image.

13. At least one non-transitory computer readable storage medium comprising a set of instructions which, when executed by a computing device, cause the computing device to:
obtain an image of an individual wearing a headset;
determine a head orientation of the individual based on the image; and
adjust a soundscape delivered to the individual via the headset based on the head orientation of the individual.

14. The at least one non-transitory computer readable storage medium of claim 13, wherein the instructions, when executed, cause a computing device to adjust one or more of an audio delivery time difference between left and right channels of the soundscape, a volume difference between left and right channels of the soundscape and a frequency component of the soundscape.

15. The at least one non-transitory computer readable storage medium of claim 14, wherein the frequency component is to include a Doppler effect.

16. The at least one non-transitory computer readable storage medium of claim 13, wherein the instructions, when executed, cause a computing device to determine an intermediate orientation of the head of the individual relative to a mobile device, and wherein the head orientation is to be determined based on the intermediate orientation.

17. The at least one non-transitory computer readable storage medium of claim 16, wherein the instructions, when executed, cause a computing device to use a camera embedded in the mobile device to obtain the image.

18. The at least one non-transitory computer readable storage medium of claim 13, wherein the instructions, when executed, cause a computing device to use a peripheral camera to obtain the image.

19. An apparatus comprising:
logic, implemented at least partly in fixed-functionality hardware, to:
obtain an image of an individual wearing a headset,
determine a head orientation of the individual based on the image, and
adjust a soundscape delivered to the individual via the headset based on the head orientation of the individual.

20. The apparatus of claim 19, wherein the logic is to adjust one or more of an audio delivery time difference between left and right channels of the soundscape, a volume difference between left and right channels of the soundscape and a frequency component of the soundscape.

21. The apparatus of claim 20, wherein the frequency component is to include a Doppler effect.

22. The apparatus of claim 19, wherein the logic is to determine an intermediate orientation of the head of the individual relative to a mobile device, and wherein the head orientation is to be determined based on the intermediate orientation.

23. The apparatus of claim 22, wherein the logic is to use a camera embedded in the mobile device to obtain the image.

24. The apparatus of claim 19, wherein the logic is to use a peripheral camera to obtain the image.
